(19) United States
(12) Patent Application Publication
(10) Pub. No.: US 2018/0075261 A1
(43) Pub. Date: Mar. 15, 2018

(54) MANAGING CONTENT PROCESSED BY DEVICE

(71) Applicant: INTERNATIONAL BUSINESS MACHINES CORPORATION, Armonk, NY (US)

(72) Inventors: Kohichi Kamijoh, Kawasaki (JP); Seiji Munetoh, Kawasaki (JP)

(21) Appl. No.: 15/263,886

(22) Filed: Sep. 13, 2016

(51) Int. Cl. G06F 21/78; G06F 21/62

(52) U.S. Cl. CPC G06F 21/78; G06F 21/62

(57) ABSTRACT

A computer implemented method for managing a content processed by a device includes: enabling a first content to be written to the device, the first content having been obtained using a first encrypted content and a device key in the device, the first encrypted content having been obtained using the first content and the device key outside the device, the device key being unique to the device and set in the device. The method further enables a second content to be read from the device, the second content having been obtained using a second encrypted content and the device key outside the device, the second encrypted content having been obtained using the second content and the device key in the device, the second content having been obtained using the first content in the device.

### BACKGROUND

The present invention relates to managing a content processed by a device.

Recently, various techniques have been known regarding managing content processed by a device.

### SUMMARY

According to an embodiment of the present invention, there is provided a computer implemented method for managing a content processed by a device. The method includes enabling a first content to be written to the device. The first content has been obtained using a first encrypted content and a device key in the device. The first encrypted content has been obtained using the first content and the device key outside the device. The device key is unique to the device and set in the device. The method further includes enabling a second content to be read from the device. The second content has been obtained using a second encrypted content and the device key outside the device. The second encrypted content has been obtained using the second content and the device key in the device. The second content has been obtained using the first content in the device.

According to another embodiment of the present invention, there is provided an apparatus for managing a content processed by a device. The apparatus includes a processor and a memory coupled to the processor. The memory includes program instructions. The program instructions are executable by the processor to cause the processor to enable a first content to be written to the device. The first content has been obtained using a first encrypted content and a device key in the device. The first encrypted content has been obtained using the first content and the device key outside the device. The device key is unique to the device and set in the device. The program instructions are executable by the processor to further cause the processor to enable a second content to be read from the device. The second content has been obtained using a second encrypted content and the device key outside the device. The second encrypted content has been obtained using the second content and the device key in the device. The second content has been obtained using the first content in the device.

According to yet another embodiment of the present invention, there is provided a device for processing a content. The device includes a key storage for storing a device key unique to the device. The device further includes a first content storage for storing a first content obtained using a first encrypted content and the device key in the device. The first encrypted content has been obtained using the first content and the device key outside the device. The device furthermore includes a second content storage for storing a second content obtained using the first content in the device. The second content is to be used with the device key to obtain a second encrypted content in the device. The second encrypted content is to be used with the device key to obtain the second content outside the device.

### BRIEF DESCRIPTION OF THE DRAWINGS

FIG. 1 depicts a block diagram of a device handling system according to exemplary embodiments of the present invention.

FIG. 2 depicts an example of a hardware configuration of a device constituting the device handling system.

FIG. 3 depicts an example of a hardware configuration of a key management system or a service provider constituting the device handling system.

FIG. 4 depicts an example of a tree structure of a set of device keys used in exemplary embodiments of the present invention.

FIG. 5 depicts a sequence chart representing an example of an operation of the device handling system according to exemplary embodiments of the present invention.

### DETAILED DESCRIPTION

Hereinafter, exemplary embodiments of the present invention will be described in detail with reference to the attached drawings.

It is to be noted that the present invention is not limited to these exemplary embodiments to be given below and may be implemented with various modifications within the scope of the present invention. In addition, the drawings used herein are for purposes of illustration, and may not show actual dimensions.

Miniaturization of semiconductor devices has realized ultra-small (e.g., 100 nanometers by 100 nanometers) computers at a low cost. In such circumstances, applications are required to be written securely to multiple ultra-small computers at the same time, and data obtained by executing the applications are required to be read securely from multiple ultra-small computers at the same time. Further, lifecycles of the ultra-small computers are required to be managed securely.

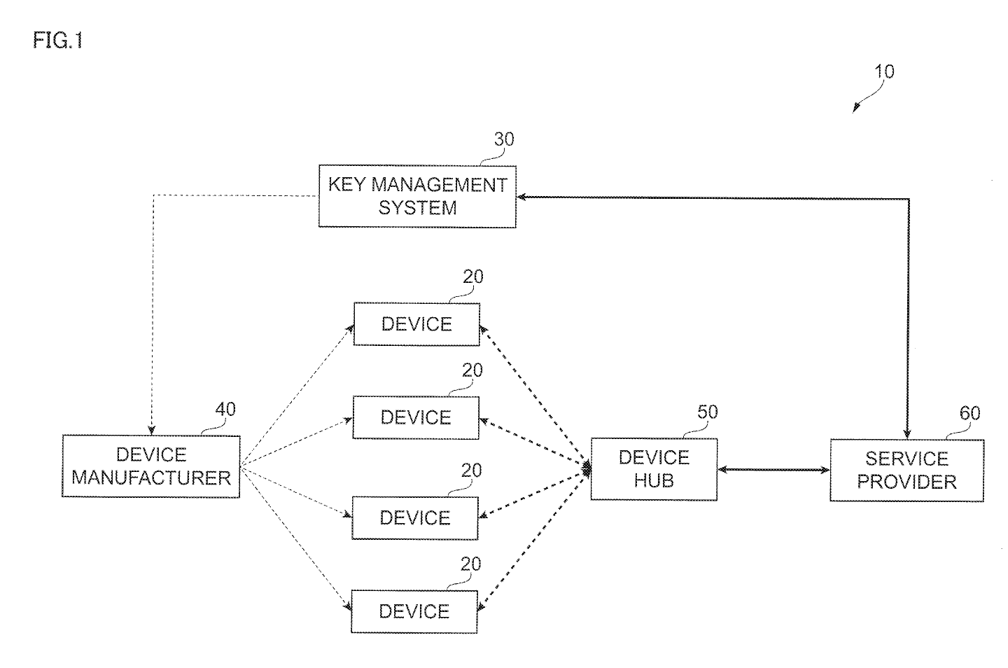

Referring to FIG. 1, there is shown a block diagram of a device handling system 10 to which the exemplary embodiments are applied. As shown in the figure, the device handling system 10 can include devices 20, a key management system 30, a device manufacturer 40, a device hub 50, and a service provider 60. The key management system 30 and the service provider 60 can be connected by a wired connection, as indicated by a thick solid line. The device hub 50 and the service provider 60 can also be connected by a wired connection, as indicated by a thick solid line. The devices 20 and the device hub 50 can be connected by a wireless connection, as indicated by thick broken lines.

The devices 20 can be the ultra-small computers described above, which are so small as to be indistinguishable to human eyes. The devices 20 can obtain data (e.g., sensor data) by executing an application (e.g. an application using sensor functions). From another point of view, the devices 20 may have anti-tamper capabilities. The devices 20 can be system on chip (SoC) implemented or multi-chip module (MCM) implemented. In FIG. 1, four devices 20 are illustrated, but any number of devices 20 can be included in the device handling system 10.

The key management system 30 can be a computer which generates and manages pairs of device IDs and device keys. Each of the device IDs can identify one of the devices 20, and each of the device keys can be assigned uniquely to one of the devices 20. The key management system 30 serves as one example of a second apparatus having a device key.

The device manufacturer 40 can be a person or a company which manufactures the devices 20. The device manufacturer 40 can embed, during manufacturing process of the devices 20, each of the pairs of the device IDs and the device keys provided by the key management system 30 to one of the devices 20.

The device hub 50 can be an instrument which communicates with the plural devices 20 simultaneously. The device hub 50 can be the only instrument to access the devices 20. Specifically, the device hub 50 can be used to write the application to the devices 20 and to read the data obtained by executing the application from the devices 20. However, the device hub 50 may be unable to access raw data obtained by executing the application.

The service provider 60 can be a computer which provides the application (e.g. an application using sensor functions) to the devices 20, and which analyzes the data (e.g., sensor data) obtained in the devices 20 by executing the application. The service provider 60 serves as one example of a first apparatus.

For example, the device handling system 10 can be applicable to medical services. A medical service provider can provide the devices 20 and an application to a medical staff such as doctors, nurses, and the like. The medical staff can mount the devices 20 in the device hub 50, and can operate the device hub 50 to install the application to the devices 20. Then, the medical staff can attach each of the devices 20 to a patient so that the application acquires medical data regarding the patient. Next, the medical staff can mount the devices 20 in the device hub 50, and can operate the device hub 50 to look at the medical data.

Next, a hardware configuration of each of the devices 20 is described.

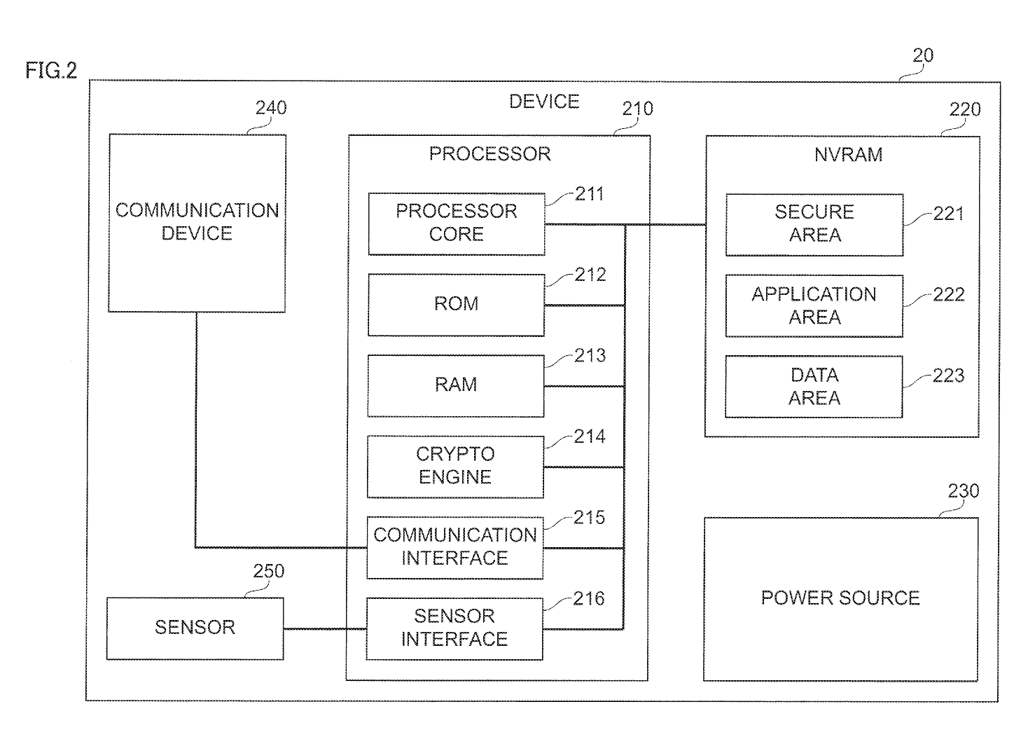

Referring to FIG. 2, there is shown an example of a hardware configuration of a device 20. As shown in the figure, the device 20 can include a processor 210, a non-volatile random access memory (NVRAM) 220, a power source 230, a communication device 240, and a sensor 250.

The processor 210 can control the whole operation of the device 20. The processor 210 can include a processor core 211. The processor 210 can include a read-only memory (ROM) 212 which stores a boot loader. The boot loader can be a program which has been embedded at the time of manufacture and cannot be rewritten. The boot loader can load only the application legitimately encrypted by an application key (to be described later). The processor 210 can include a random access memory (RAM) 213 which stores a code of the application and data obtained by executing the application. The processor 210 can include a crypto engine 214 which performs encryption processing and decryption processing. However, whether the encryption processing is to be performed can be determined based on a policy. For example, the encryption processing can be disabled depending on a kind of the application or data. The processor 210 may further include a communication interface 215 and a sensor interface 216.

The NVRAM 220 can include a secure area 221 which stores pairs of device IDs and device keys. The device IDs can be read-only. The device keys can only be read by the crypto engine 214. The device keys can only be deleted by the application. The NVRAM 220 can include an application area 222 which stores an application provided by the service provider 60. The application area 222 is empty at the time of shipment of the device 20, and the application is written to the application area 222 at the time of use of the device 20. The NVRAM 220 can further include a data area 223 which stores data obtained by executing the application.

The power source 230 can be a source of electric power. The power source 230 can be a battery, a power generator, or the like.

The communication device 240 can be a device for communicating with the device hub 50. The communication device 240 can be a radio-frequency (RF) device, an optical communication device, or the like.

The sensor 250 can be a device which acquires data to be analyzed. For example, the sensor 250 can acquire medical data when the device 20 is mounted on a human body.

Next, a hardware configuration of the key management system 30 and the service provider 60 is described. Note that the key management system 30 and the service provider 60 have the same hardware configuration, so the description will be for the hardware configuration of a computer 90.

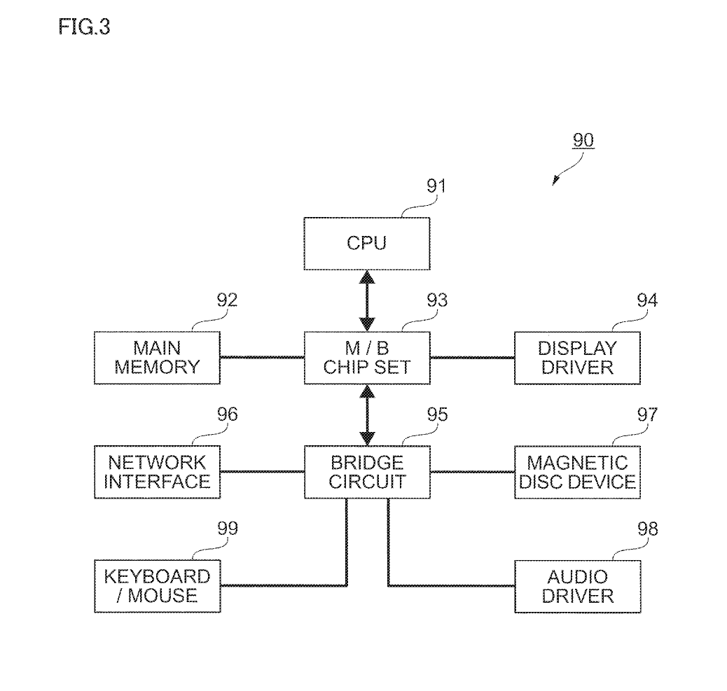

Referring to FIG. 3, there is shown an example of a hardware configuration of the computer 90. As shown in the figure, the computer 90 can include a central processing unit (CPU) 91 serving as one example of a processor, a main memory 92 connected to the CPU 91 via a motherboard (M/B) chip set 93 and serving as one example of a memory, and a display driver 94 connected to the CPU 91 via the same M/B chip set 93. A network interface 96, a magnetic disk device 97, an audio driver 98, and a keyboard/mouse 99 are also connected to the M/B chip set 93 via a bridge circuit 95.

In FIG. 3, the various configurational elements are connected via buses. For example, the CPU 91 and the M/B chip set 93, and the M/B chip set 93 and the main memory 92 are connected via CPU buses, respectively. Also, the M/B chip set 93 and the display driver 94 may be connected via an accelerated graphics port (AGP). However, when the display driver 94 includes a PCI express-compatible video card, the M/B chip set 93 and the video card are connected via a PCI express (PCIe) bus. Also, when the network interface 96 is connected to the bridge circuit 95, PCI Express can be used for the connection, for example. For connecting the magnetic disk device 97 to the bridge circuit 95, serial AT attachment (ATA), parallel-transmission ATA, or peripheral components interconnect (PCI) can be used. For connecting the keyboard/mouse 99 to the bridge circuit 95, universal serial bus (USB) can be used.

Here, a structure of a set of the device keys managed by the key management system 30 is described.

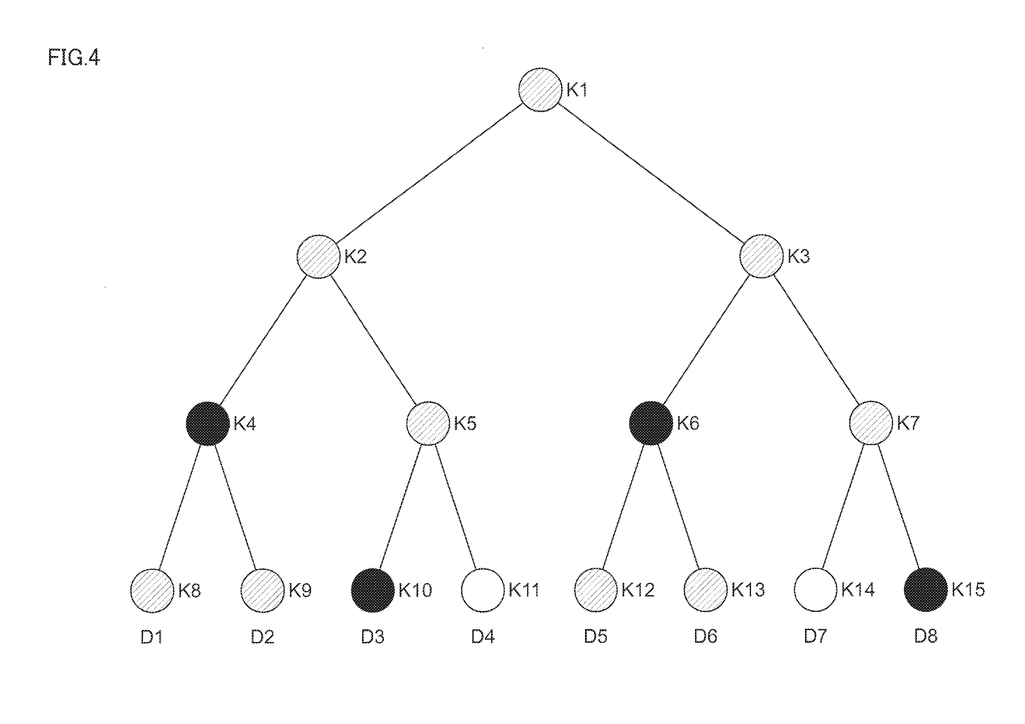

Referring to FIG. 4, there is shown an example of a tree structure of a set of the device keys. In FIG. 4, the key management system 30 is assumed to manage the device keys K1 to K15, each of which is assigned to any one of nodes of the tree structure. Each of the devices D1 to D8 is assumed to correspond to any one of eight leaf nodes of the tree structure. Further, each of the devices D1 to D8 can have device keys assigned for nodes from the leaf node corresponding to the device to the root node of the tree structure at the time of shipment of the device 20. For example, the device D3 can have the device keys K1, K2, K5, and K10.

Assume that an encrypted application and one or more encrypted application keys are sent to the devices D1 to D8. The encrypted application is assumed to be obtained by encrypting an application with an application key, and the one or more encrypted application keys are assumed to be obtained by encrypting the application key with one or more device keys. If the application is allowed to be used in the devices D1 to D8, an encrypted application key obtained by encrypting the application key with the device key K1 may be sent to the devices D1 to D8. It is because all of the devices D1 to D8 have the device key K1. On the other hand, if the application is allowed to be used in the devices except for the devices D4 and D7 (corresponding to the nodes indicated by white circles), encrypted application keys obtained by encrypting the application key with the device keys K4, K6, K10, and K15 (assigned to the nodes indicated by black circles) may be sent to the devices D1 to D8. It is because each of the devices D4 and D7 has none of the device keys K4, K6, K10, and K15, and each of the remaining devices has any one of the device keys K4, K6, K10, and K15.

Next, the operation of the device handling system 10 according to the exemplary embodiments is described.

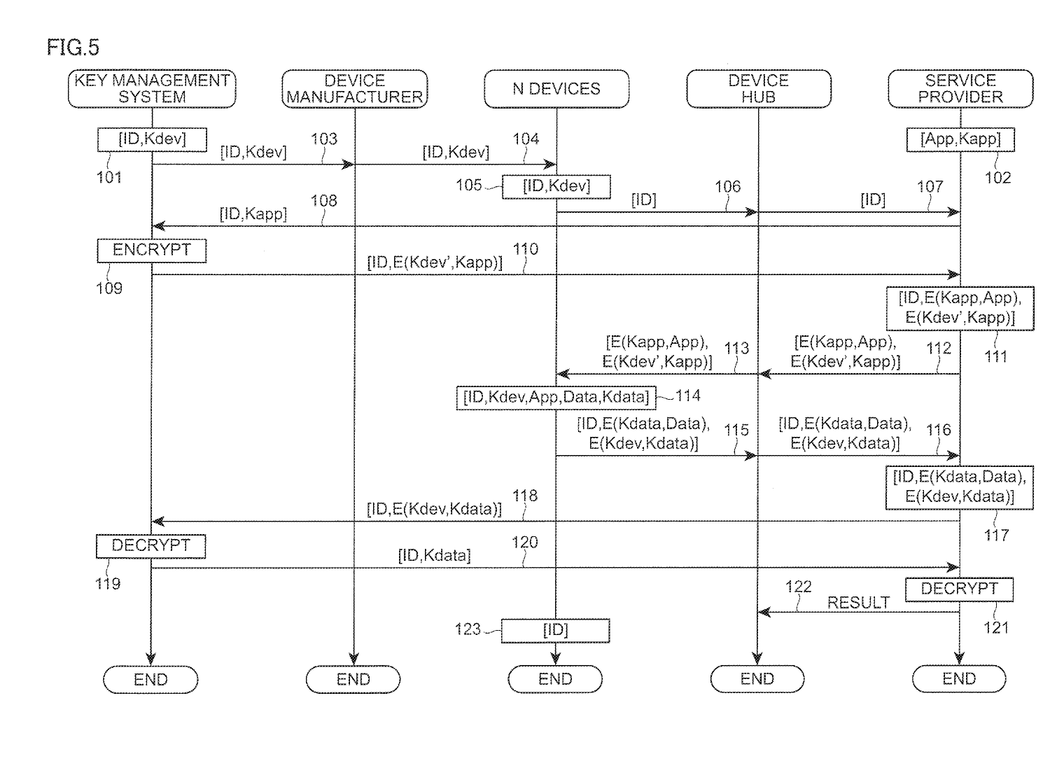

Referring to FIG. 5, there is shown a sequence chart representing an example of the operation of the device handling system 10 according to the exemplary embodiments. Note that, in the sequence chart, [A, B, C, . . . ] denotes sets of A, B, C, . . . , and E(X, Y) denotes an encrypted content obtained by encrypting a content Y with a key X.

As shown in the figure, the key management system 30 can first generate plural sets of ID and Kdev (step 101). Note that a symbol “ID” denotes a device ID and a symbol “Kdev” denotes a device key. Meanwhile, the service provider 60 can hold plural sets of App and Kapp (step 102). Note that a symbol “App” denotes an application serving as one example of a first content, and a symbol “Kapp” denotes an application key. The service provider 60 can obtain plural applications, and can generate plural application keys each corresponding to one of the plural applications.

The device manufacturer 40 can retrieve N sets of ID and Kdev from the plural sets of ID and Kdev (step 103), and can write each of the N sets of ID and Kdev to corresponding one of N devices 20 at the time of manufacturing of the N devices 20 (step 104). Thus, the N devices 20 can hold the N sets of ID and Kdev (step 105). The device hub 50 can read each of N sets of ID from corresponding one of the N devices 20 (step 106), and can send the N sets of ID to the service provider 60 (step 107).

Subsequently, the service provider 60 can send N sets of ID and Kapp to the key management system 30 (step 108). The key management system 30 can obtain E(Kdev′, Kapp) by encrypting Kapp with Kdev′ (step 109). Note that a symbol “Kdev′” denotes a specific set of the device keys. The specific set of the device keys can be determined by which leaf nodes correspond to the N devices 20 in the tree structure of the plural device keys managed by the key management system 30. In the example of FIG. 4, if the N devices 20 are the devices except for the devices D4 and D7, the specific set of the device keys can be the device keys K4, K6, K10, and K15. Thus, the key management system 30 can obtain a set of E(K4, Kapp), E(K6, Kapp), E(K10, Kapp), and E(K15, Kapp) as E(Kdev′, Kapp). The key management system 30 can send N sets of ID and E(Kdev′, Kapp) to the service provider 60 (step 110).

Thus, the service provider 60 can obtain E(Kapp, App) by encrypting App with Kapp, and can hold N sets of ID, E(Kapp, App), and E(Kdev′, Kapp) (step 111). The service provider 60 can send N sets of E(Kapp, App) and E(Kdev′, Kapp) to the device hub 50 (step 112), and the device hub 50 can send each of the N sets of E(Kapp, App) and E(Kdev′, Kapp) to corresponding one of the N devices 20 (step 113). Note that a set of E(Kapp, App) and E(Kdev′, Kapp) serves as one example of a first encrypted content.

Thus, each of the N devices 20 can hold one of N sets of ID, Kdev, App, Data, and Kdata (step 114). Specifically, each of the N devices 20 can obtain Kapp by decrypting E(Kdev′, Kapp) with Kdev assigned to the own device 20. In the example of FIG. 4, if the N devices 20 are the devices except for the devices D4 and D7, the devices D1 and D2 can use the device key K4 as Kdev, the device D3 can use the device key K10 as Kdev, the devices D5 and D6 can use the device key K6 as Kdev, and the device D8 can use the device key K15 as Kdev. Each of the N devices 20 can obtain App by decrypting E(Kapp, App) with Kapp thus obtained. Then, each of the N devices 20 can obtain Data by executing the application indicated by App thus obtained. Note that data indicated by Data serves as one example of a second content. Each of the N devices 20 can generate Kdata, for example, by using random numbers.

The N devices 20 can send N sets of ID, E(Kdata, Data), and E(Kdev, Kdata) to the device hub 50 (step 115), and the device hub 50 can send the N sets of ID, E(Kdata, Data), and E(Kdev, Kdata) to the service provider 60 (step 116). E(Kdata, Data) can be obtained by encrypting Data with Kdata in the N devices 20, and E(Kdev, Kdata) can be obtained by encrypting Kdata with Kdev in the N devices 20. Thus, the service provider 60 can hold the N sets of ID, E(Kdata, Data), and E(Kdev, Kdata) (step 117). Note that a set of E(Kdata, Data) and E(Kdev, Kdata) serves as one example of a second encrypted content.

The service provider 60 can send N sets of ID and E(Kdev, Kdata) to the key management system 30 (step 118). The key management system 30 can obtain Kdata by decrypting E(Kdev, Kdata) with Kdev assigned to the device identified by ID (step 119). The key management system 30 can send N sets of ID and Kdata to the service provider 60 (step 120). The service provider 60 can obtain Data by decrypting E(Kdata, Data) with Kdata (step 121). After that, the service provider 60 can analyze the data indicated by Data, and can send the analysis results to the device hub 50 (step 122). Alternatively, the service provider 60 can disclose the analysis results, for example, on a Web page, instead of sending them to the device hub 50.

After the data indicated by Data has been read from the device 20, the application can delete Kdev (step 123). This deletion of Kdev can prevent the device 20 from being used any more.

Alternatively, after the data indicated by Data has been read from the device 20, the key management system 30 can register the device 20 as having been used. Then, the key management system 30 can respond that the device 20 has been used, in response to a request for any one of encryption processing and decryption processing. This management of the device 20 can prevent the device 20 from being used any more. For example, any application can be prevented from being written to the device 20.

The above description shows that the device 20 has the following states: “New”, “Use”, and “Disposal”. The state “New” can be the state just after manufacturing of the device 20. In this state, the device 20 can contain the device ID, the device key, and the boot loader. The state “Use” can be the state where the device 20 has a legitimate application and the legitimate application is running on the device 20. The state “Disposal” can be the state where use of the device 20 has ended and reuse of the device 20 is prohibited.

Next, an alternative exemplary embodiment will be described. In the alternative exemplary embodiment, the key management system 30 and the service provider 60 can be integrated to a single apparatus. In this case, exchanges of data between the key management system 30 and the service provider 60 at steps 108, 110, 118 and 120 can be replaced with exchanges of data between a key management process and a service providing process in the single apparatus.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for managing a content processed by a device, the method comprising:
enabling a first content to be written to the device, the first content having been obtained using a first encrypted content and a device key in the device, the first encrypted content having been obtained using the first content and the device key outside the device, the device key being unique to the device and set in the device; and
enabling a second content to be read from the device, the second content having been obtained using a second encrypted content and the device key outside the device, the second encrypted content having been obtained using the second content and the device key in the device, the second content having been obtained using the first content in the device.

2. The method of claim 1, wherein
the first content is an application, and
the first encrypted content includes an encrypted application and an encrypted application key, the encrypted application having been obtained by encrypting the application with an application key, the encrypted application key having been obtained by encrypting the application key with the device key.

3. The method of claim 2, wherein the enabling the first content to be written to the device further includes:
transmitting the application key from a first apparatus to a second apparatus having the device key; and
transmitting the encrypted application key from the second apparatus to the first apparatus.

4. The method of claim 2, wherein
the second content is a data piece having been obtained by executing the application, and
the second encrypted content includes an encrypted data piece and an encrypted data key, the encrypted data piece having been obtained by encrypting the data piece with a data key, the encrypted data key having been obtained by encrypting the data key with the device key.

5. The method of claim 4, wherein the enabling the second content to be read from the device further includes:
transmitting the encrypted data key from a first apparatus to a second apparatus having the device key; and
transmitting the data key from the second apparatus to the first apparatus.

6. The method of claim 1, further comprising preventing the device from being used, after the second content has been read from the device.

7. An apparatus for managing a content processed by a device, the apparatus comprising:
a processor; and
a memory coupled to the processor, wherein
the memory comprises program instructions executable by the processor to cause the processor to:
enable a first content to be written to the device, the first content having been obtained using a first encrypted content and a device key in the device, the first encrypted content having been obtained using the first content and the device key outside the device, the device key being unique to the device and set in the device; and
enable a second content to be read from the device, the second content having been obtained using a second encrypted content and the device key outside the device, the second encrypted content having been obtained using the second content and the device key in the device, the second content having been obtained using the first content in the device.

8. A device for processing a content, the device comprising:
a key storage for storing a device key unique to the device;
a first content storage for storing a first content obtained using a first encrypted content and the device key in the device, the first encrypted content having been obtained using the first content and the device key outside the device; and
a second content storage for storing a second content obtained using the first content in the device, the second content being to be used with the device key to obtain a second encrypted content in the device, the second encrypted content being to be used with the device key to obtain the second content outside the device.

9. The device of claim 8, wherein the first content deletes the device key, after the second content has been read from the device.
